(19) United States
(12) Patent Application Publication
(10) Pub. No.: US 2026/0189592 A1
(43) Pub. Date: Jul. 2, 2026

(54) DETERMINING VULNERABILITY OF COMPUTATIONAL RESOURCES TO ATTACK VECTORS

(71) Applicant: INTERNATIONAL BUSINESS MACHINES CORPORATION, ARMONK, NY (US)

(72) Inventors: OMRI SOCEANU, Haifa (IL); FADY COPTY, Nazareth (IL); DAVID HADAS, Zichron Ya'akov (IL)

(21) Appl. No.: 19/008,310

(22) Filed: Jan. 2, 2025

(51) Int. Cl. H04L 9/40

(52) U.S. Cl. CPC H04L 63/1433; H04L 63/1483

(57) ABSTRACT

Provided are a computer implemented method, system, and computer program product for determining vulnerability of computational resources to attack vectors. A potential attack vector is detected that is directed to a targeted resource of the computational resources that matches a known attack vector of a plurality of known attack vectors. Attributes of attack vectors directed to the targeted resource are processed, including the attributes of the known attack vector, to generate a vulnerability score for the targeted resource indicating a likelihood the targeted resource is exposed to a malicious attack. A lower vulnerability score indicates the targeted resource is less susceptible to the malicious attack than a higher vulnerability score. An alert is generated in response to determining that the generated vulnerability score indicates an increased vulnerability to the malicious attack.

### BACKGROUND OF THE INVENTION

### 1. Field of the Invention

The present invention relates to a computer implemented method, system, and computer program product for determining vulnerability of computational resources to attack vectors.

### 2. Description of the Affected Art

Cyber resiliency efforts for enterprise data are directed to protecting against malicious access and attacks on data, such as ransomware attacks. If there is a malicious attack, cyber resilience efforts focus on data recovery to recover data from backups. Enterprise systems may also deploy malware detection and intrusion detection software at servers and client systems. This deployment requires significant computational resources to perform data validation and execute anomaly detection algorithms to detect potentially malicious activities based on patterns of accesses.

### SUMMARY

Provided are a computer implemented method, system, and computer program product for determining vulnerability of computational resources to attack vectors. A potential attack vector is detected that is directed to a targeted resource of the computational resources that matches a known attack vector of a plurality of known attack vectors. Attributes of attack vectors directed to the targeted resource are processed, including the attributes of the known attack vector, to generate a vulnerability score for the targeted resource indicating a likelihood the targeted resource is exposed to a malicious attack. A lower vulnerability score indicates the targeted resource is less susceptible to the malicious attack than a higher vulnerability score. An alert is generated in response to determining that the generated vulnerability score indicates an increased vulnerability to the malicious attack.

### BRIEF DESCRIPTION OF THE DRAWINGS

FIG. 1 illustrates an embodiment of a network computing environment.

FIG. 2 illustrates an embodiment of an attack vector record having information on attack vector attributes directed to a computational resource.

FIG. 3 illustrates an embodiment of a resource vulnerability record having information on attack vectors directed to a given computational resource.

FIG. 4 illustrates an embodiment of operations to determine a vulnerability score of computational resources subject to a malicious attack based on an attack vector directed to a targeted computational resource.

FIG. 5 illustrates a computing environment in which the components of FIG. 1 may be implemented.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description herein provides examples of embodiments of the invention, and variations and substitutions may be made in other embodiments. Several examples will now be provided to further clarify various embodiments of the present disclosure:

Example 1: A computer implemented method comprising for protecting computational resources in a network environment from malicious cybersecurity attacks. The method comprises detecting a potential attack vector directed to a targeted resource of the computational resources that matches a known attack vector of a plurality of known attack vectors. The method further comprises processing attributes of attack vectors directed to the targeted resource, including the attributes of the known attack vector, to generate a vulnerability score for the targeted resource indicating a likelihood the targeted resource is exposed to a malicious attack. A lower vulnerability score indicates the targeted resource is less susceptible to the malicious attack than a higher vulnerability score. The method further comprises generating an alert in response to determining that the generated vulnerability score indicates an increased vulnerability to the malicious attack. Thus, embodiments advantageously allow generating in real-time an updated vulnerability score indicating a vulnerability of a resource targeted by a known attack vector based on attributes of attack vectors directed to the targeted resource, including the just detected known attack vector and other attack vectors.

Example 2: The limitations of any of Examples 1 and 3-11 may optionally include that the processing attributes of attack vectors directed to the targeted resource to generate the vulnerability score further comprises processing attributes of attack vectors directed to the targeted resource prior to detecting the potential attack vector. Thus, embodiments advantageously allow for the vulnerability score to cumulatively reflect attack vectors directed to the targeted resource prior to the currently detected attack vector.

Example 3: The limitations of any of Examples 1, 2, and 4-11 may optionally include the method maintaining a resource database having information on attack vectors directed to the computational resources. The method further comprises updating the resource database to indicate the matching known attack vector for the targeted resource. Thus, embodiments advantageously allow for a resource database to maintain information on attack vectors that have attacked computational resources and updating the resource database to indicate the current detected known attack vector to allow. By reflecting current and past information in the resource database, accurate determinations of the vulnerability score may be based on the current and previous attack vectors directed to computational resources.

Example 4: The limitations of any of Examples 1-3 and 5-11 may optionally include that the known attack vectors are selected from the group consisting of compromised access credentials at the targeted resource, compromised credentials at another computational resource affected by the potential attack vector, phishing attack against users of the targeted resource, unpatched software at the targeted resource, malware installed at the targeted resource, an attempted access to the targeted resource from a network address on a deny list of network addresses, misconfiguration of settings affecting the targeted resource, a brute force attack to access the targeted resource, a denial of service attack at the targeted resource, and privilege levels granted to users of the targeted resource. Thus, embodiments advantageously allow for detection of known attack vectors of numerous types having different attack vector paths toward the targeted resource to have the vulnerability score reflect the risk from a multitude of different types of attacks.

Example 5: The limitations of any of Examples 1-4 and 6-11 may optionally include that the attributes of the known and potential attack vectors indicate a method to gain unauthorized access, a component that performs a malicious activity once the unauthorized access is attained, and a reconnaissance comprising information gathered about the targeted resource to facilitate the malicious activity. Thus, embodiments advantageously allow for consideration of key aspects of an attack vector when determining the vulnerability score, including the method to gain access, the component performing malicious activity, and the reconnaissance technique to capture the key components of risk of the attack vectors. This advantageously allows for a more robust vulnerability score.

Example 6: The limitations of any of Examples 1-5 and 7-11 may optionally include determining related resources such that attack vectors directed to the related resources are likely to impact the targeted resource. The method further comprises determining attributes of attack vectors directed to the related resources, wherein the processing the attributes of the attack vectors for the targeted resource to generate the vulnerability score further comprises additionally processing the attributes of attack vectors directed to the related resources to generate the vulnerability score for the targeted resource. Thus, embodiments advantageously allow for the vulnerability score for a targeted resource to consider the attack vector risk to related resources such that the targeted resource is exposed to the attack vector risk at the related resources. This advantageously allows for a more robust vulnerability score that considers attributes of attack vectors at other resources in the network.

Example 7: The limitations of any of Examples 1-6 and 8-11 may optionally include that the related resources include a resource connected to the targeted resource over a network. Thus, embodiments advantageously allow for the vulnerability score for a targeted resource to consider the attack vector risk at related resources connected to the targeted resource.

Example 8: The limitations of any of Examples 1-7 and 9-11 may optionally include determining related resources such that attack vectors directed to the related resources are likely to impact the targeted resource. The method further comprises determining vulnerability scores of the related resources indicating vulnerability of the related resources to a malicious attack. The processing the attributes of the attack vectors directed to the targeted resource further includes processing the determined vulnerability scores of the related resources to generate the vulnerability score for the targeted resource. Thus, embodiments advantageously allow for the vulnerability score for a targeted resource to consider the calculated vulnerability scores for related resources such that the targeted resource is exposed to the attack vector risk at the related resources. This advantageously allows for a more robust vulnerability score that considers vulnerability scores at other resources in the network.

Example 9: The limitations of any of Examples 1-8, 10, and 11 may optionally include in response to determining that the generated vulnerability score indicates an increased vulnerability to a malicious attack, determining affected resources likely to be affected by the potential attack vector directed to the targeted resource. The method further comprises processing attributes of attack vectors directed to the affected resources and the attributes of attack vectors at the targeted resource, including the attributes of the known attack vector, to generate an updated vulnerability score for the affected resources. Thus, embodiments advantageously allow for the vulnerability scores to be updated for affected resources that are likely to be affected by the attack vector at the targeted resources. This advantageously allows for more robust vulnerability scores for affected resources in the network to be updated with attributes of a newly detected attack vector at the targeted resource likely to affect the affected resources.

Example 10: The limitations of any of Examples 1-9 and 11 may optionally include in response to determining that the generated vulnerability score indicates an increased vulnerability to the malicious attack, determining affected resources likely to be affected by the potential attack vector directed to the targeted resource. The method further comprises processing attributes of attack vectors directed to the affected resources and the vulnerability score for the targeted resource to generate an updated vulnerability score for the affected resources. Thus, embodiments advantageously allow for the vulnerability scores to be updated for affected resources that are likely to be affected by the attack vector at the targeted resources. This advantageously allows for more robust vulnerability scores for affected resources in the network to be updated to reflect a newly calculated vulnerability score at the targeted resource subject to the detected attack vector.

Example 11: The limitations of any of Examples 1-10 may optionally include that the processing the attributes of the attack vectors directed to the targeted resource to generate the vulnerability score comprises inputting the attributes of the attack vectors directed to the targeted resource, including the attributes of the known attack vector, to a classifier machine learning model to output a vulnerability score for the targeted resource. Thus, embodiments advantageously allow for a machine learning model to calculate the vulnerability score based on the attributes of attack vectors directed to the targeted resource.

Example 12 is an apparatus comprising means to perform a method of any of the Examples 1-11.

Example 13 is a machine-readable storage including machine-readable instructions, that when executed, implement a method or realize an apparatus of any of the Examples 1-11.

Example 14: A system comprising one or more processor and one or more computer-readable storage media collectively storing program instructions which, when executed by the processor, are configured to cause the processor to perform a method according to any of Examples 1-11.

Example 15: A computer program product comprising one or more computer readable storage media, and program instructions collectively stored on the one or more computer readable storage media, the program instructions comprising instructions configured to cause one or more processors to perform a method according to any one of Examples 1-11.

Additionally, or alternatively, an embodiment where Example 1 includes determining related resources such that attack vectors directed to the related resources are likely to impact the targeted resource. The method further comprises determining attributes of attack vectors directed to the related resources, wherein the processing the attributes of the attack vectors for the targeted resource to generate the vulnerability score further comprises additionally processing the attributes of attack vectors directed to the related resources and the determined vulnerability scores of the related resources to generate the vulnerability score for the targeted resource. Thus, embodiments advantageously allow for the vulnerability score for a targeted resource to consider the attack vector risk to related resources and the calculated vulnerability scores for related resources such that the targeted resource is exposed to the attack vector risk at the related resources. This advantageously allows for a more robust vulnerability score that considers attributes of attack vectors and vulnerability scores at other resources in the network.

Additionally, or alternatively, an embodiment where Example 1 includes, in response to determining that the generated vulnerability score indicates an increased vulnerability to a malicious attack, determining affected resources likely to be affected by the potential attack vector directed to the targeted resource. The method further comprises processing attributes of attack vectors directed to the affected resources, the attributes of attack vectors at the targeted resource, including the attributes of the known attack vector, and the vulnerability score for the targeted resource to generate an updated vulnerability score for the affected resources. Thus, embodiments advantageously allow for the vulnerability scores to be updated for affected resources that are likely to be affected by the attack vector at the targeted resources. This advantageously allows for more robust vulnerability scores for affected resources in the network to be updated with attributes of a newly detected attack vector and the update vulnerability score at the targeted resource likely to affect the affected resources.

Security perimeter mindset allows security trade-offs of resources that are not exposed to attack vectors. For example, web application firewall (WAF) rules that inspect network traffic content do not apply to internal network traffic. These trade-offs weaken the security posture and may pose critical security risks if the system is breached. An infrastructure-as-code (IaC) developer designs the network infrastructure under the assumption that no breach exists, and that the security attack vector analysis is static. This view of an attack vector environment may lead to situations where security monitoring generates evidence that a resource is suspected as breached, and that the attack vector analysis is no longer valid. However, the IaC developer may not be aware of this change in attack vector analysis and may not perform the required changes to the IaC design for the network environment. This is caused by the assumption that security teams will fix the problems. However, often the security administrator ignores medium risks because they are not aware of the attack vectors.

Described embodiments provide improvements to computer technology for managing threats to computational resources in a network from attack vectors by determining a vulnerability score for a targeted resource for which an alert of a potential attack vector is detected. A computational resource may comprise one or more of hardware, software, cloud computing resources, etc. Alerts may be collected by different security tools distributed across the network. The vulnerability score may be based on attack vector attributes for recently received attack vector alerts for the targeted resource. Further, in a network environment, a computational resource vulnerability to a malicious attack can be impacted by attack vectors received at other computational resources in the environment.

Described embodiments further provide improvements to determine the vulnerability score to a malicious attack by considering attack vector attributes of other computational resources whose attack vectors could threaten the vulnerability of the targeted resource. Yet further, the vulnerability score for computational resources affected by attack vectors at the targeted resource may be updated based on the attack vector received at the targeted computational resource.

Providing an accurate analysis of the vulnerability of connected computational resources in the network environment allows for timely alerts to system administrators to take action to protect against malicious attacks. Further, the IaC developer of the system infrastructure may be alerted to new security vulnerabilities of specific computational resources so they can adjust the design of the infrastructure code to void the risk of potential attack vectors causing a critical change to the vulnerability score of computational resources in the system.

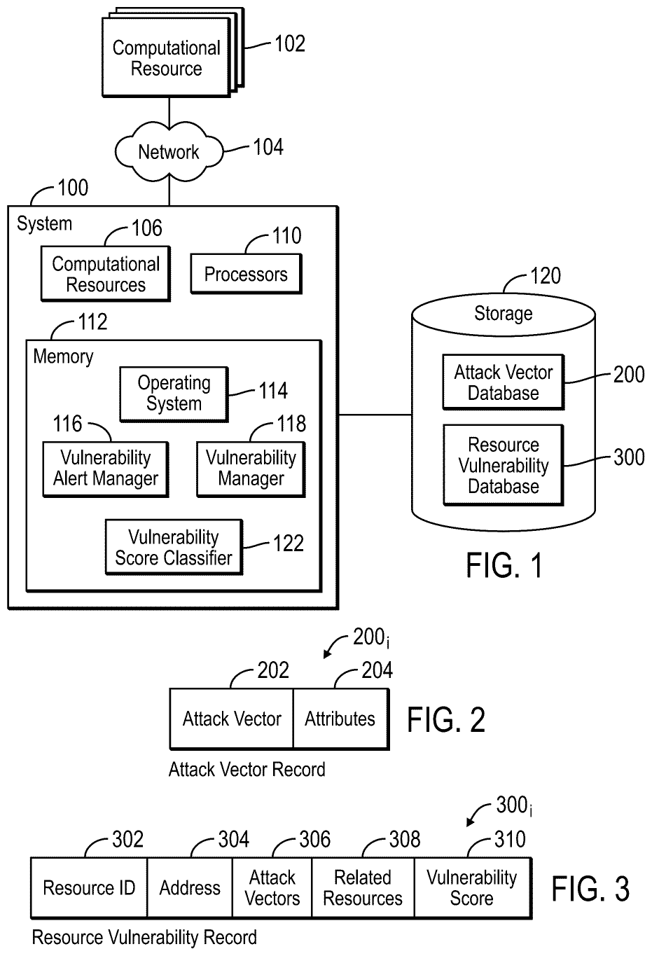

FIG. 1 illustrates an embodiment of a network computing environment. A system 100 communicates with computational resources 102 over a network 104. The computational resources 102 may be deployed in computer systems connected to the network 104, such as databases, web-servers, applications, firewall devices, routers, or any software and/or hardware resource that may be susceptible to attack vectors. The system 100 may also include computational resources 106 susceptible to attack vectors. The network 104 and connected devices may comprise an enterprise network or cloud computing environment.

An attack vector comprises a path that a malicious actor uses to gain unauthorized access to a network, server, application, database or device by exploiting system vulnerabilities. Following is a non-exhaustive list of examples of different attack vectors used by malicious actors to compromise system resources. A malicious actor may use phishing or brute force attacks to gain an authorized user's credentials to maliciously access network resources. Unpatched software at computational resources and the hardware that hosts computational resources may expose security flaws that malicious actors can exploit. Lack of encryption may expose data to access by malicious actors, including malicious insiders in an organization who otherwise have access to organization resources. Misconfiguration of computational resources as well as misconfiguration of the systems that host the computational resources may create attack vectors within the settings or design of the application, database or systems. Over granting high level access privileges can result in an attack vector if a malicious actor obtains a high level privilege. Trust relationships between computational resources allow certain resources automatic access to other resources. A malicious actor gaining access to one computational resource may then exploit trust relationships as an attack vector to gain access to other network computational resources part of the trust relationship. A denial of service (DoS) attack vector is when the malicious actor seeks to overwhelm network resources, such as servers, applications and websites, by flooding them with overwhelming traffic or messages to cause the resources to shut down. A malicious actor may transmit malicious commands to a resource, such as Application Programming Interface (API) commands and structured query language (SQL) commands, to database resources to exfiltrate information or corrupt the resource. A man-in-the middle attack vector is when the malicious actor intercepts communications between resources to steal information.

The system 100 includes one or more processors 110 and a memory 112 including programs executed by the processors 110. The memory 112 may include an operating system 114 and a vulnerability alert manager 116 to process alerts of attack vectors at the computational resources 102, 106. There may be distributed attack vector detection tools throughout the network 104. The attack vector detection tools upon detecting an attack vector at a computational resource 102, 106 may forward information on the detected attack vector to the vulnerability alert manager 116 to process. The distributed attack vector detection tools generating attack vector alerts may comprise cloud based workload security tools, including network security tools that generate and collect alerts about resource egress activity, system security tools that generate and collect alerts about suspicious system activity, vulnerability detection tools that generate and collect alerts about vulnerable images in a computational resource, and activity insights that generate and collect alerts about suspicious data exfiltration. These different types of attack vector collection tools may indicate that a resource is suspected to be impacted by malicious activity.

An attack vector database 200 in a storage 120 has information on known attack vectors. FIG. 2 illustrates is an embodiment of an attack vector record 200ᵢ including an attack vector identifier 202 and attributes 204 of the attack vector. Attributes 204 of the attack vector may include a method or technique to take advantage of a vulnerability or weakness in the system to gain unauthorized access to a system or resource. Attributes 204 may also include a technique, program or script that performs the malicious activity once unauthorized access has been attained, such as a virus, worm, ransomware or other type of malware designed to cause harm or steal data. Another attribute of an attack vector includes reconnaissance techniques of how the attack vector gathers information about the target resource, such as scanning for vulnerabilities, identifying open ports or collecting information about employees and system. This information gained through reconnaissance may then be used to plan and execute the attack by exploiting detected vulnerabilities.

A vulnerability manager 118 manages the received attack vector alerts. The vulnerability manager 118 may update a resource vulnerability database 300 in the storage 120 with information on the received attack vectors directed to a computational resource 102, 106.

With respect to FIG. 3, a resource vulnerability record 300ᵢ in the vulnerability database 300 includes information on a computational resource and attack vectors directed to the resource. The record 300ᵢ may include: a resource identifier 302, such as a unique ID of the resource; a network address 304 of the resource 302; one or more attack vectors 306 that have been directed to the resource 302; related resources 308, such as IDs and/or addresses, of other computational resources such that an attack vector directed to the related resource is likely to impact or threaten the targeted resource 302; and a vulnerability score 310 calculated from attributes 204 of the attack vectors 306 directed to the target resource 302 and attributes of attack vectors directed to the related resources 308. Indicated attack vectors 306 having an occurrence time exceeding an expiration time may be removed from the resource vulnerability record.

Attack vectors at related resources 308 may directly or indirectly impact the targeted resource and, thus, increase the vulnerability of the targeted resource to a malicious attack. The related resources 308 may be connected over the network 104 to the targeted resource 302, within a system of the targeted resource 302 or in a trusted relationship with the targeted resource 302. This relationship causes the targeted resource to be susceptible to attacks directed to the related resource.

The related resources for a targeted resource may alternatively be determined from a resource graph, not from field 308. A resource graph comprises a directed graph defining connections of attack vector interaction paths among different resources in the network 104. Each path in the directed graph between resources may be associated with a direction in which the attack vector moves between resources and a weight indicating the strength or likelihood an attack vector at one resource could affect another resource.

A vulnerability score classifier 122 may receive as input attributes for the attack vectors 306 directed to a targeted resource and attributes of attack vectors directed to related resources of the targeted resource. The vulnerability score classifier 122 may also receive as input vulnerability scores for related resources. The classifier 122 may process the input to output a vulnerability score 310 along with a confidence level indicating a probability the vulnerability score is correct. The vulnerability score may indicate a probability that a malicious attack will occur at the resource 302 based on the detected attack vectors at the resource 302 itself and related resources 308. A higher vulnerability score may indicate a higher likelihood of malicious activity occurring at the targeted resource than a lower vulnerability score.

The storage 120 may comprise one or more non-volatile storage devices known in the art. The storage 120 may comprise an array of storage device units, such as Just a Bunch of Disks (JBOD), Direct Access Storage Device (DASD), Redundant Array of Independent Disks (RAID) array, virtualization device, etc.

The memory 112 may comprise a suitable volatile or non-volatile memory devices, including those described above.

The network 104 may comprise a Storage Area Network (SAN), a Local Area Network (LAN), a Wide Area Network (WAN), the Internet, and Intranet, etc.

Generally, program modules, such as the program components 102, 106, 114, 116, 118, 122, among others, may comprise routines, programs, objects, components, logic, data structures, and so on that perform particular tasks or implement particular abstract data types. The program components and hardware devices of the system may be implemented in one or more storage systems or computer systems, where if they are implemented in multiple storage systems or computer systems, then the storage systems or computer systems may communicate over a network or a bus.

The program components 102, 106, 114, 116, 118, 122, among others, may be accessed by a processor from memory to execute. Alternatively, some or all of the program components 102, 106, 114, 116, 118, 122, among others, may be implemented in separate hardware devices, such as Application Specific Integrated Circuit (ASIC) hardware devices, Data Processing Units (DPUs), and/or Field Programmable Gate Arrays (FPGAs).

The functions described as performed by the program components 102, 106, 114, 116, 118, 122, among others, may be implemented as program code in fewer program modules than shown or implemented as program code throughout a greater number of program modules than shown.

Program components implementing machine learning models, such as program classifier 122 and vulnerability manager 118, may be implemented in an Artificial Intelligence (AI) hardware accelerator, such as an FPGA or a graphics processing unit (GPU).

In certain embodiments, the classifier 122 and vulnerability manager 118 may use machine learning and deep learning algorithms, such as decision tree learning, association rule learning, neural network, inductive programming logic, support vector machines, Bayesian network, Recurrent Neural Networks (RNN), Feedforward Neural Networks, Convolutional Neural Networks (CNN), Deep Convolutional Neural Networks (DCNNs), Generative Adversarial Network (GAN), etc. For artificial neural network program implementations, the neural network may be trained using backward propagation to adjust weights and biases at nodes in a hidden layer to produce their output based on the received inputs. In backward propagation to train the classifier 122, biases at nodes in the hidden layer are adjusted accordingly to produce the output, such as one of multiple classifications of the attack vector attributes as a vulnerability score indicating a likelihood of a successful malicious attack occurring, with specified confidence levels based on the input parameters. Backward propagation maybe used to train the vulnerability manager 118 may include an attack vector classifier to classify attributes of the potential attack vector as one of the known attack vectors in the attack vector database. Backward propagation may comprise an algorithm for supervised learning of artificial neural networks using gradient descent. Given an artificial neural network and an error function, the method may use gradient descent to find the parameters (coefficients) for the nodes in a neural network or function that minimizes a cost function measuring the difference or error between actual and predicted values for different parameters. The parameters are continually adjusted during gradient descent to minimize the error.

In backward propagation used to train a neural network machine learning model implementing the classifier 122 and vulnerability manager 118, a margin of error is determined based on a difference of the calculated vulnerability scores and user rankings of the outputs. Biases (parameters) at nodes in the hidden layer are adjusted accordingly to minimize the margin of error of the error function.

In an alternative embodiment, the classifier 122 and vulnerability manager 118 attack vector classifier may be implemented not as a machine learning model, but implemented as a heuristic model using a rules based system to determine the outputs from the inputs, or be implemented in methods other than neural networks, such as multivariable linear regression models. The classifier 122 and vulnerability manager attack vector classifier may also be implemented using an unsupervised machine learning module.

The system 100 may comprise a server or production site of an enterprise to which the vulnerability components 116, 118, 122 are deployed to determine vulnerability of computational resources in the network to attack vectors and take protective action based on a change in the vulnerability score. The protective action may comprise alerting an administrator, quarantining access to the targeted resource, and triggering recovery mechanisms of affected data, such as recovering backups or snapshots of the computational resource or data that are stored based on the backup strategy of a user/enterprise.

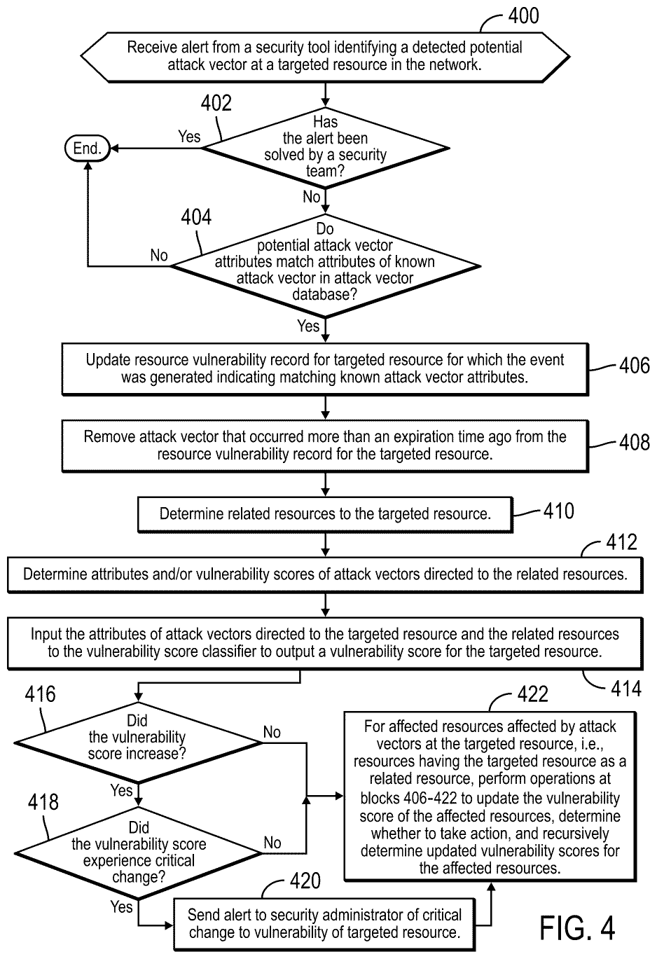

FIG. 4 illustrates an embodiment of operations performed by the vulnerability alert manager, vulnerability manager and vulnerability score classifier. In certain embodiments, the vulnerability alert manager, vulnerability manager and vulnerability score classifier may comprise the components 116, 118, and 122, respectively, described above with respect to FIG. 1. Upon receiving (at block 400) an alert from a security tool identifying a detected potential attack vector at a targeted resource in the network, such as a computational resource, the vulnerability alert manager determines (at block 402) whether the attack vector has been solved or addressed by a security team or IaC developer. If so, then control ends. Otherwise, if (at block 402) the attack vector of the alert has not been addressed or solved, then the vulnerability manager may determine (at block 404) whether attributes of a detected potential attack vector match attributes of one of the known attack vectors in the attack vector database 200. The vulnerability alert manager may vectorize attributes of the potential attack vector to compare with vectorized attributes of the attributes of known attack vectors to determine if the vectorized attributes of one of the known attack vectors is within a distance threshold of the vectorized attributes of the potential attack vector. The distance may comprise a spatial measurement in the vector space.

Other techniques may be used to determine a closest match of attributes for one known attack vector in the attack vector database with attributes of the potential attack vector. This allows for determining whether the potential attack vector comprises one of the known attack vectors based on matching attributes. In an alternative embodiment, the vulnerability manager may include a machine learning classifier trained to receive as input attributes of the potential attack vector to determine a closest known attack vector to the potential attack vector.

If (at block 404) the potential attack vector does not match one of the known attack vectors, then control ends. Otherwise, if there is a match, then the vulnerability manager updates (at block 406) the resource vulnerability record for the targeted resource to indicate the matching known attack vector, such as in field 306.

The vulnerability manager may remove (at block 408) attack vectors that occurred with respect to the targeted resource more than an expiration time ago from the resource vulnerability record for the targeted resource. A determination is made (at block 410) of related resources whose attack vectors could impact the targeted resource. The related resources for the targeted resource may be determined from related resource information, e.g., 308, or a graph showing how attack vectors to resources impact other resources. The vulnerability manager may determine (at block 412) attributes of attack vectors from attack vector records and/or determine vulnerability scores 310 from the related vulnerability records of the related resources. The attributes of attack vectors directed to the targeted resource and the related resources are inputted (at block 414) to the vulnerability score classifier to output a vulnerability score for the targeted resource indicating a likelihood or probability the potential attack vector will result in malicious activity at the targeted resource.

If (at block 416) the vulnerability score increased from a previous calculated vulnerability score, then the vulnerability manager determines (at block 418) whether the vulnerability score experienced a critical change. A critical change may comprise a change of the vulnerability score to a higher score exceeding a threshold change differential, e.g., more than 10%, etc. If (at block 418) the change in score was critical, then the vulnerability manager may send (at block 420) an alert to a security administrator of the critical change to the vulnerability of the targeted resource. The security administrator may then take appropriate action to isolate the attack vector and block malicious activity from the attack vector. Further, the vulnerability manager may also take action to block the malicious activity. For instance, the vulnerability manager may quarantine the targeted resource from further access, take an immediate snapshot or backup of the targeted resource and its data, take an immediate snapshot or backup of databases on which the targeted resource operates, etc. Yet further, the alert may be sent to the IaC developer to determine whether to modify the infrastructure code to address this potential attack vector. The IaC developer may modify the infrastructure code of the targeted resources and other computational resources impacted by the potential attack vector.

From the NO branches of blocks 416 or 476 or block 420, control proceeds to block 422 to recursively calculate the vulnerability score for affected resources affected by the potential attack vector directed to the targeted resource. Affected resources may have vulnerability database records indicating the targeted resource as a related resource. For each affected resource, the operations at blocks 406-422 may be performed to update the vulnerability score of the affected resource, determine whether to take action, and recursively determine updated vulnerability scores for another level of affected resources affected by attack vectors at the current considered affected resource.

The update to vulnerability scores may be recursively performed for affected resources of considered affected resources to extend through a graph or tree of relationships among computational resources. In this way, resources directly or indirectly affected by an attack vector at a targeted resource may have their vulnerability score updated. Further, although the change in the vulnerability score at the targeted resource due to the attack vector may not result in corrective action, the impact of the attack vector on other affected resources, directly and indirectly impacted, may cause a change in the vulnerability score for the affected resources that results in corrective action.

The present invention may be a system, a method, and/or a computer program product. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

In the flowcharts and description, when there is a condition with different operations described as performed depending on the result of the condition, all results of the condition may occur at different times resulting in the different operations performed for the different results of the condition at different times.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

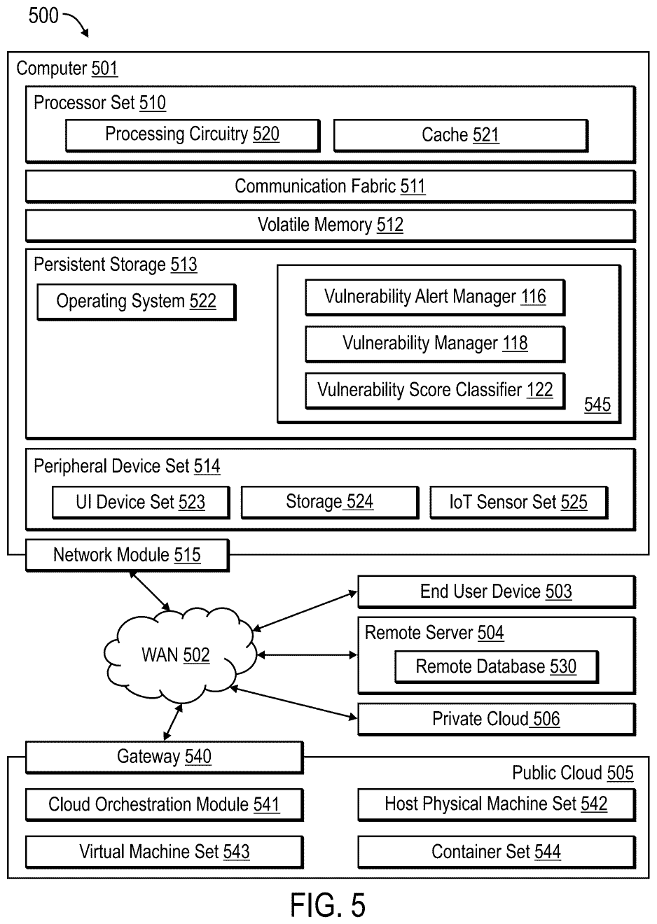

With respect to FIG. 5, computing environment 500 contains an example of an environment for the execution of at least some of the computer code involved in performing the inventive methods, such as the vulnerability alert manager 116, vulnerability manager 118, and vulnerability score classifier 122 included in block 545 to update the vulnerability score for a computational resource targeted by an attack vector. In addition to block 545, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 545, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer-readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 545 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in block 545 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer-readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on. The EUD 503 may include computational resources monitored by the vulnerability alert manager 116 and vulnerability manager 118.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504. The remote server 504 may include computational resources managed by the vulnerability alert manager 116 and vulnerability manager 118. Further, the attack vector database 200 and resource vulnerability database 300 may be maintained at the remote database 530.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

CLOUD COMPUTING SERVICES AND/OR MICROSERVICES (not separately shown in FIG. 5): private and public clouds 506 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The letter designators, such as i among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer implemented method for protecting computational resources in a network environment from malicious cybersecurity attacks, comprising:
detecting a potential attack vector directed to a targeted resource of the computational resources that matches a known attack vector of a plurality of known attack vectors; and
processing attributes of attack vectors directed to the targeted resource, including the attributes of the known attack vector, to generate a vulnerability score for the targeted resource indicating a likelihood the targeted resource is exposed to a malicious attack, wherein a lower vulnerability score indicates the targeted resource is less susceptible to the malicious attack than a higher vulnerability score; and
generating an alert in response to determining that the generated vulnerability score indicates an increased vulnerability to the malicious attack.

2. The computer implemented method of claim 1, wherein the processing attributes of attack vectors directed to the targeted resource to generate the vulnerability score further comprises processing attributes of attack vectors directed to the targeted resource prior to detecting the potential attack vector.

3. The computer implemented method of claim 1, further comprising:
maintaining a resource database having information on attack vectors directed to the computational resources; and
updating the resource database to indicate the matching known attack vector for the targeted resource.

4. The computer implemented method of claim 1, wherein the known attack vectors are selected from the group consisting of compromised access credentials at the targeted resource, compromised credentials at another computational resource affected by the potential attack vector, phishing attack against users of the targeted resource, unpatched software at the targeted resource, malware installed at the targeted resource, an attempted access to the targeted resource from a network address on a deny list of network addresses, misconfiguration of settings affecting the targeted resource, a brute force attack to access the targeted resource, a denial of service attack at the targeted resource, and privilege levels granted to users of the targeted resource.

5. The computer implemented method of claim 1, wherein the attributes of the known and potential attack vectors indicate a method to gain unauthorized access, a component that performs a malicious activity once the unauthorized access is attained, and a reconnaissance comprising information gathered about the targeted resource to facilitate the malicious activity.

6. The computer implemented method of claim 1, further comprising:
determining related resources such that attack vectors directed to the related resources are likely to impact the targeted resource; and
determining attributes of attack vectors directed to the related resources, wherein the processing the attributes of the attack vectors for the targeted resource to generate the vulnerability score further comprises additionally processing the attributes of attack vectors directed to the related resources to generate the vulnerability score for the targeted resource.

7. The computer implemented method of claim 6, wherein the related resources include a resource connected to the targeted resource over a network.

8. The computer implemented method of claim 1, further comprising:
determining related resources such that attack vectors directed to the related resources are likely to impact the targeted resource; and
determining vulnerability scores of the related resources indicating vulnerability of the related resources to a malicious attack, wherein the processing the attributes of the attack vectors directed to the targeted resource further includes processing the determined vulnerability scores of the related resources to generate the vulnerability score for the targeted resource.

9. The computer implemented method of claim 1, further comprising:
in response to determining that the generated vulnerability score indicates an increased vulnerability to a malicious attack, determining affected resources likely to be affected by the potential attack vector directed to the targeted resource; and
processing attributes of attack vectors directed to the affected resources and the attributes of attack vectors at the targeted resource, including the attributes of the known attack vector, to generate an updated vulnerability score for the affected resources.

10. The computer implemented method of claim 1, further comprising:
in response to determining that the generated vulnerability score indicates an increased vulnerability to the malicious attack, determining affected resources likely to be affected by the potential attack vector directed to the targeted resource; and
processing attributes of attack vectors directed to the affected resources and the vulnerability score for the targeted resource to generate an updated vulnerability score for the affected resources.

11. The computer implemented method of claim 1, wherein the processing the attributes of the attack vectors directed to the targeted resource to generate the vulnerability score comprises:
inputting the attributes of the attack vectors directed to the targeted resource, including the attributes of the known attack vector, to a classifier machine learning model to output a vulnerability score for the targeted resource.

12. A computer system for protecting computational resources in a network environment from malicious cybersecurity attacks comprising:
a processor set;
one or more computer-readable storage media; and
program instructions stored on the one or more computer-readable storage media to cause the processor set to perform operations comprising:
detecting a potential attack vector directed to a targeted resource of the computational resources that matches a known attack vector of a plurality of known attack vectors; and
processing attributes of attack vectors directed to the targeted resource, including the attributes of the known attack vector, to generate a vulnerability score for the targeted resource indicating a likelihood the targeted resource is exposed to a malicious attack, wherein a lower vulnerability score indicates the targeted resource is less susceptible to the malicious attack than a higher vulnerability score; and
generating an alert in response to determining that the generated vulnerability score indicates an increased vulnerability to the malicious attack.

13. The system of claim 12, wherein the operations further comprise:
determining related resources such that attack vectors directed to the related resources are likely to impact the targeted resource; and
determining attributes of attack vectors directed to the related resources, wherein the processing the attributes of the attack vectors for the targeted resource to generate the vulnerability score further comprises additionally processing the attributes of attack vectors directed to the related resources to generate the vulnerability score for the targeted resource.

14. The system of claim 12, wherein the operations further comprise:
determining related resources such that attack vectors directed to the related resources are likely to impact the targeted resource; and
determining vulnerability scores of the related resources indicating vulnerability of the related resources to a malicious attack, wherein the processing the attributes of the attack vectors directed to the targeted resource further includes processing the determined vulnerability scores of the related resources to generate the vulnerability score for the targeted resource.

15. The system of claim 12, wherein the operations further comprise:
in response to determining that the generated vulnerability score indicates an increased vulnerability to a malicious attack, determining affected resources likely to be affected by the potential attack vector directed to the targeted resource; and
processing attributes of attack vectors directed to the affected resources and the attributes of attack vectors at the targeted resource, including the attributes of the known attack vector, to generate an updated vulnerability score for the affected resources.

16. The system of claim 12, wherein the operations further comprise:
in response to determining that the generated vulnerability score indicates an increased vulnerability to the malicious attack, determining affected resources likely to be affected by the potential attack vector directed to the targeted resource; and
processing attributes of attack vectors directed to the affected resources and the vulnerability score for the targeted resource to generate an updated vulnerability score for the affected resources.

17. A computer program product for protecting computational resources in a network environment from malicious cybersecurity attacks, comprising:
one or more computer-readable storage media; and
program instructions stored on the one or more computer-readable storage media to perform operations comprising:
detecting a potential attack vector directed to a targeted resource of the computational resources that matches a known attack vector of a plurality of known attack vectors; and
processing attributes of attack vectors directed to the targeted resource, including the attributes of the known attack vector, to generate a vulnerability score for the targeted resource indicating a likelihood the targeted resource is exposed to a malicious attack, wherein a lower vulnerability score indicates the targeted resource is less susceptible to the malicious attack than a higher vulnerability score; and
generating an alert in response to determining that the generated vulnerability score indicates an increased vulnerability to the malicious attack.

18. The computer program product of claim 17, wherein the operations further comprise:
determining related resources such that attack vectors directed to the related resources are likely to impact the targeted resource; and
determining attributes of attack vectors directed to the related resources, wherein the processing the attributes of the attack vectors for the targeted resource to generate the vulnerability score further comprises additionally processing the attributes of attack vectors directed to the related resources to generate the vulnerability score for the targeted resource.

19. The computer program product of claim 17, wherein the operations further comprise:
determining related resources such that attack vectors directed to the related resources are likely to impact the targeted resource; and
determining vulnerability scores of the related resources indicating vulnerability of the related resources to a malicious attack, wherein the processing the attributes of the attack vectors directed to the targeted resource further includes processing the determined vulnerability scores of the related resources to generate the vulnerability score for the targeted resource.

20. The computer program product of claim 17, wherein the operations further comprise:
in response to determining that the generated vulnerability score indicates an increased vulnerability to a malicious attack, determining affected resources likely to be affected by the potential attack vector directed to the targeted resource; and
processing attributes of attack vectors directed to the affected resources and the attributes of attack vectors at the targeted resource, including the attributes of the known attack vector, to generate an updated vulnerability score for the affected resources.
